(19) United States
(12) Patent Application Publication
(10) Pub. No.: US 2026/0369581 A1
(43) Pub. Date: Nov. 19, 2026

(54) CATHODE ACTIVE MATERIAL COATED WITH LITHIUM TANTALATE - HAFNATE AND ALL-SOLID-STATE BATTERY COMPRISING SAME

(71) Applicant: Factorial Inc., Billerica, MA (US)

(72) Inventors: Minh Nguyen, Lowell, MA (US); Yuying Steven Lin, Billerica, MA (US); Joanna Burdynska, Billerica, MA (US); Fang Hao, Andover, MA (US); Hyun Seok Kim, Lexington, MA (US)

(21) Appl. No.: 19/635,928

(22) Filed: Apr. 1, 2026

Related U.S. Application Data
(60) Provisional application No. 63/808,016, filed on May 19, 2025.

(51) Int. Cl. H01M 4/485; C01G 35/00; H01M 4/131; H01M 4/36; H01M 4/62

(52) U.S. Cl. CPC H01M 4/485; C01G 35/006; H01M 4/131; H01M 4/366; H01M 4/625; H01M 4/628; C01P 2004/80; C01P 2006/40

(57) ABSTRACT

Disclosed is a cathode active material particle at least partially coated with a coating of lithium tantalate-hafnate represented by a formula of (LiTaO₃)₁₋ₓ—(Li₂HfO₃)ₓ, 0<x<1.00. In some embodiments, 0.03≤x≤0.25. In some embodiments, x has a value of around 0.95. A cathode active material layer comprising the coated CAM and an all-solid-state battery (ASSB) comprising the cathode active material layer are also disclosed. In some embodiments, the ASSB exhibits a good high-rate performance and a desired cycling performance.

### CROSS-REFERENCE

The present application claims the benefit of U.S. Ser. No. 63/808,016, filed May 19, 2025, the entire content of which is incorporated herein by reference into this application.

### TECHNICAL FIELD

The present disclosure relates to a cathode active material coated with lithium tantalate-hafnate and an all-solid-state battery (ASSB) comprising the same.

### BACKGROUND

All-solid-state batteries (ASSBs) are considered as promising candidates for future energy storage devices as they may enable the use of lithium metal as anode material and lead to higher specific energies compared to conventional lithium-ion batteries based on organic liquid electrolytes. Sulfide solid electrolyte (SE) materials comprise element sulfur in the −2 oxidation state (S⁻²) and have narrow intrinsic electrochemical windows. Thiophosphate-based solid electrolytes (SEs) contain elements phosphorus (P) and sulfur (S) and are particularly promising because of their high ionic conductivities, good mechanical compatibility, and relatively low costs. The passivation of SEs is necessary for the reversible operation of all-solid-state batteries. Conventional high-capacity cathode active materials (CAMs) such as lithium metal oxide CAMs may lead to high interfacial resistances. Thus, a new cathode active material is desired for sulfide-based ASSB batteries with improved electrochemical stability and high-rate capabilities.

### SUMMARY

Disclosed herein is a coated cathode active material particle comprising a particle of a cathode active material (CAM) and a coating of lithium tantalate-hafnate at least partially covering surface of the particle. In some embodiments, the lithium tantalate-hafnate is represented by a formula of (LiTaO₃)₁₋ₓ—(Li₂HfO₃)ₓ; 0<x<1.0. In some embodiments, 0.03≤x≤0.25. In some embodiments, 0.85<x<1.00. A cathode active material layer comprising the coated CAM particle and an all-solid-state battery (ASSB) comprising the same are also disclosed. Methods for preparing the same are also disclosed.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows a representative structure of a cathode active material layer according to one embodiment of the present disclosure.

FIG. 2 shows an all-solid-state battery (ASSB) according to one embodiment of the present disclosure.

FIG. 3A shows a plot of discharge capacity retention (%) vs. cycle number at 75 °C of half-cells according to one embodiment of the present disclosure.

FIG. 3B shows a plot of discharge capacity retention (%) vs. cycle number at 75 °C of half-cells according to one embodiment of the present disclosure.

FIG. 4A shows a plot of discharge capacity retention (%) vs. cycle number at 75 °C of half-cells according to one embodiment of the present disclosure.

FIG. 4B shows a plot of discharge capacity retention (%) vs. cycle number at 75 °C of half-cells according to one embodiment of the present disclosure.

### DETAILED DESCRIPTION

The present disclosure provides coated cathode active material particle comprising a particle of a cathode active material (CAM) and a coating of lithium tantalate-hafnate at least partially covering surface of the particle. In some embodiments, the lithium tantalate-hafnate is represented by a formula of (LiTaO₃)₁₋ₓ—(Li₂HfO₃)ₓ; 0<x<1.0. In some embodiments, 0.03≤x≤0.25. In some embodiments, 0.85<x<1.00.

In some embodiments, the coated CAM is incorporated into a cathode active material layer as representatively shown in FIG. 1. A particle (1) of a cathode active material (CAM) is coated by (LiTaO₃)₁₋ₓ—(Li₂HfO₃)ₓ as a coating layer (2) (1 and 2 collectively coated CAM particle). As shown in FIG. 1, a cathode active material layer comprises a coated CAM particle, an inorganic or sulfide solid electrolyte (3) and an electronically conductive carbon fiber (4) as an electrically conductive material.

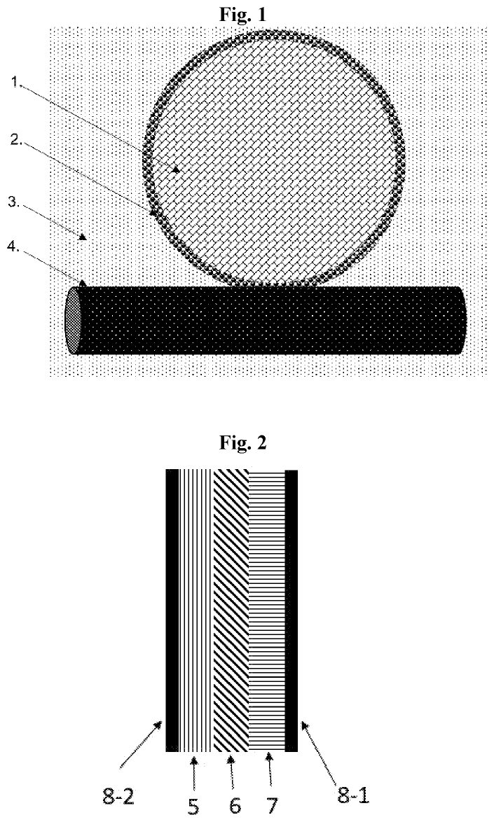

FIG. 2 shows a typical structure of an all-solid-state battery (ASSB) comprising a cathode active material layer (5), a solid electrolyte (6), an anode active material layer (7), a first current collector (8-1) in contact with the anode active material layer (7), and a second current collector (8-2) in contact with the cathode active material layer (5). The first current collector (8-1) (alternatively anode current collector) and the anode active material layer (7) are collectively termed as “anode layer”. The second current collector (8-2) (alternatively cathode current collector) and the cathode active material layer (5) are collectively termed as “cathode layer”.

In some embodiments, 0.03≤x≤0.25. In some embodiments, 0.85<x<1.0. In some embodiments, x has a value around 0.95. In some embodiments, the (LiTaO₃)₁₋ₓ—(Li₂HfO₃)ₓ is represented by a formula selected from the group consisting of (LiTaO₃)_{0.97}—(Li₂HfO₃)_{0.03}, (LiTaO₃)_{0.95}—(Li₂HfO₃)_{0.05}, (LiTaO₃)_{0.90}—(Li₂HfO₃)_{0.10}, (LiTaO₃)_{0.85}—(Li₂HfO₃)_{0.15}, (LiTaO₃)_{0.80}—(Li₂HfO₃)_{0.20}, (LiTaO₃)_{0.75}—(Li₂HfO₃)_{0.25}, (LiTaO₃)_{0.05}—(Li₂HfO₃)_{0.95}, and mixtures thereof.

In some embodiments, the molar ratio of Ta to Hf is important. In some embodiments, the Hf/Ta molar ratio is equal to or greater than 3/97 and equal to or less than 25/75. In some embodiments, the Hf/Ta molar ratio has a molar ratio around 95/5.

In some embodiments, the CAM includes without limitation Liₓ₁Mn_{1-y}M_{y}A₂, Liₓ₁Mn_{1-y}M_{y}O_{2-z}X_{z}, Liₓ₁Mn₂O_{4-z}X_{z}, Liₓ₁Mn_{2-y}M_{y}A₄, Liₓ₁Co_{1-y}M_{y}A₂, LiₓCo_{1-y}M_{y}O_{2-z}X_{z}, Liₓ₁Ni_{1-y}M_{y}A₂, Liₓ₁Ni_{1-y}M_{y}O_{2-z}X_{z}, Liₓ₁Ni_{1-y}Co_{y}O_{2-z}X_{z}, Liₓ₁Ni_{1-y-z}Co_{y}M_{z}Aₐ, Liₓ₁Ni_{1-y-z}Co_{y}M_{z}O₂₋ₐXₐ, Liₓ₁Ni_{1-y}-Mn_{y}M_{z}Aₐ, Liₓ₁Ni_{1-y-z}Mn_{y}M_{z}O₂₋ₐXₐ, Liₓ₁Ni_{1-y-z}Mn_{y}M_{z}O₂ and combinations thereof, wherein 0.95≤x1≤1.1, 0≤y≤0.5, 0≤z≤0.5, 0≤a≤2; M is selected from the group consisting of Al, Ni, Co, Mn, Cr, Fe, Mg, Sr, V, and rare earth elements; A is selected from the group consisting of O, F, S, and P; and X is selected from the group consisting of F, S, and P.

In some embodiments, the CAM is in the form of particles having a median particle size (D₅₀) diameter in a range from about 1 μm to about 15 μm, from about 1 μm to about 12 μm, from about 1 μm to about 10 μm, from about 1 μm to about 7 μm, from about 1 μm to about 6 rm, from about 3 μm to about 15 μm, from about 3 μm to about 12 μm, from about 3 μm to about 10 μm, from about 3 μm to about 7 μm, from about 3 μm to about 6 μm, from about 5 μm to about 15 μm, from about 5 μm to about 12 μm, from about 5 μm to about 10 μm and all ranges and subranges therebetween.

In some embodiments, the coated CAM particles are present in the cathode active material layer at an amount in a range from about 50 wt % to about 99 wt %, from about 50 wt % to about 95 wt %, from about 50 wt % to about 90 wt %, from about 50 wt % to about 85 wt %, from about 50 wt % to about 80 wt %, from about 55 wt % to about 99 wt %, from about 55 wt % to about 95 wt %, from about 55 wt % to about 90 wt %, from about 55 wt % to about 85 wt %, from about 55 wt % to about 80 wt %, from about 60 wt % to about 99 wt %, from about 60 wt % to about 95 wt %, from about 60 wt % to about 90 wt %, from about 60 wt % to about 85 wt %, from about 60 wt % to about 80 wt %, from about 65 wt % to about 99 wt %, from about 65 wt % to about 95 wt %, from about 65 wt % to about 90 wt %, from about 65 wt % to about 85 wt %, from about 65 wt % to about 80 wt %, from about 70 wt % to about 99 wt %, from about 70 wt % to about 95 wt %, from about 70 wt % to about 90 wt %, from about 70 wt % to about 85 wt %, from about 70 wt % to about 80 wt %, and all range and subranges therebetween based on total weight of the cathode active material layer.

In some embodiments, the coated CAM particles may be polycrystalline or single crystalline. In some embodiments, the coated CAM particles may have a single particle size distribution or multiple particle size distributions.

In some embodiments, the coating on the CAM particle may have a thickness in a range from 0.5 nm to 20 nm, from 0.8 nm to 20 nm, from 1 nm to 20 nm, from 2 nm to 20 nm, from 4 nm to 20 nm, from 10 nm to 20 nm, from 0.5 nm to 10 nm, from 1.0 nm to 10 nm, from 2 nm to 10 nm, or from 4 nm to 10 nm. In some embodiments, the coating has a thickness in a range from 0.5 nm to 8 nm, from 0.5 nm to 5 nm, from 0.5 nm to 3 nm, from 1 nm to 8 nm, from 1 nm to 5 nm, or from 1 nm to 3 nm. In some embodiments, the thickness is measured by observing the cross section of a dissected particle using a scanning electron microscope (SEM). In some embodiments, the thickness is measured on a transmission electron microscope (TEM).

In one aspect, the present disclosure provides a cathode active material layer comprising the coated CAM particle and an electrically conductive material.

In some embodiments, the electrically conductive material may be carbon fibers including but not limited to, vapor grown carbon fiber (VGCF), carbon nanotube (CNT), multi-walled carbon nanotubes (MWCNT), carbon nanofiber, and graphite fiber. In some embodiments, the electrically conductive material may have a BET measured specific surface area in a range from 1 to 600 m²/g and/or an electrical resistance of no more than 0.5 Ω·cm.

In some embodiments, the electrically conductive material may be coated with an oxide material. In some embodiments, the oxide material has an average thickness in a range from 2 nm to 50 nm. In some embodiments, the oxide material is an inorganic oxide material. In some embodiment, the inorganic oxide material is selected from the group consisting of B₂O₃, Li₃B₁₁O₁₈, Li₄B₂O₅, Li₆B₄O₉, LiBO₂, Li₂B₄O₇, Li₃B₇O₁₂, LiB₃O₅, LiNbO₃, Li₄SiO₄, Li₃PO₄, Li₂SiO₃, LiPO₃, Li₂SO₄, Li₂WO₄, Li₂MoO₄, Li₂ZrO₃, LiAlO₂, Li₂TiO₃, Li₄Ti₅O₁₂, and a composite oxide thereof.

In some embodiments, the electrically conductive material either coated or uncoated is present in the cathode active material layer at an amount in a range from 0.01 wt % to 5 wt %, 0.01 wt % to 4 wt %, 0.01 wt % to 3 wt %, 0.01 wt % to 2 wt %, 0.5 wt % to 5 wt %, 0.5 wt % to 4 wt %, 0.5 wt % to 3 wt %, 0.5 wt % to 2 wt %, 1 wt % to 5 wt %, 1 wt % to 4 wt %, 1 wt % to 3 wt %, 2 wt % to 5 wt %, 2 wt % to 4 wt %, and any or all ranges and subranges therebetween based on total weight of the cathode active material layer.

In another aspect, the present disclosure provides a cathode active material layer comprising the coated CAM particle, an electrically conductive material and an inorganic solid electrolyte.

In some embodiments, the inorganic solid electrolyte is not particularly limited to one general formula as long as it has a desired lithium-ion conductivity. In some embodiments, the inorganic solid electrolyte is a sulfide solid electrolyte. The sulfide solid electrolyte may be any of crystalline material, glass ceramic, and glass. In some embodiments, the inorganic solid electrolyte is a lithium-phosphate-sulfur (LPS) electrolyte. Examples of the sulfide solid electrolyte include Li₂S—P₂S₅, Li₂S—P₂S₅—LiHa (“Ha” is one or more halogen elements), Li₂S—P₂S₅—P₂O₅, Li₂S—Li₃PO₄—P₂S₅, Li₃PS₄, Li₄P₂S₆, Li₁₀GeP₂Si₂, Li_{3.25}Ge_{0.25}P_{0.75}S₄, Li₇P₃Si₁, Li_{3.25}P_{0.95}S₄, and Li₇₋ₓ₂PS₆₋ₓ₂Haₓ₂ (argyrodite-type solid electrolyte, “Ha” is one or more halogen elements, where 0.2<x2<1.8).

In some embodiments, the inorganic solid electrolyte (such as sulfide solid electrolyte) is present in the cathode active material layer at an amount in a range from 1 wt % to 35 wt %, from 1 wt % to 30 wt %, from 1 wt % to 25 wt %, from 1 wt % to 20 wt %, from 1 wt % to 15 wt %, 1 wt % to 10 wt %, from 5 wt % to 35 wt %, from 5 wt % to 30 wt %, from 5 wt % to 25 wt %, from 5 wt % to 20 wt %, from 5 wt % to 15 wt %, from 10 wt % to 35 wt %, from 10 wt % to 30 wt %, from 10 wt % to 25 wt %, from 10 wt % to 20 wt %, from 15 wt % to 35 wt %, from 15 wt % to 30 wt %, from 15 wt % to 25 wt %, from 20 wt % to 30 wt % and any and all ranges and subranges therebetween based on total weight of the cathode active material layer.

In one aspect, the present disclosure provides a method for preparing the coated CAM particle as described herein. Typically, a coating solution is prepared by dissolving or dispersing a predetermined amount of lithium precursor such as lithium acetate, a tantalum oxide precursor such as tantalum (V) ethoxide, a hafnium oxide precursor such as hafnium (IV) ethoxide in a solvent. In some embodiments, the predetermined amount of each precursor is calculated based on the formula (LiTaO₃)₁₋ₓ—(Li₂HfO₃)ₓ, wherein 0<x<1.0.

In some embodiments, the solvent for preparing the coating solution is a non-aqueous solvent and is selected from the group consisting of methanol, ethanol, isopropanol, n-propanol, t-butanol, tetrahydrofuran, and mixtures thereof. The coating solution can be mixed with the uncoated cathode active material to form a mixture. After the solvent is removed from the mixture, a gel is formed on the surface of the CAM particle. An annealing of the gel is conducted, whereby the lithium, silicon oxide, boron oxide, and fluoride precursors are converted into a lithium tantalate-hafnate coating on the CAM particle surface, thereby obtaining a coated CAM particle. In some embodiments, the gel is annealed at a temperature in a range from 150 °C to 500 °C for a period of time in a range from 0.5 to 3 hours under an oxygen atmosphere.

In another aspect, the present disclosure provides an all-solid-state battery (ASSB) comprising the cathode active material layer.

In some embodiments, the cathode active material layer is sandwiched between a cathode current collector and the solid electrolyte (SE) layer. In some embodiments, the cathode active material layer includes a cathode active material (CAM) that requires both lithium ion (Li⁺) and electron (e−) connectivity with the solid electrolyte layer and current collector, respectively. The Li⁺ connectivity is mainly provided by small particles of sulfide-based solid electrolyte in the cathode active material layer, and the e− connectivity is mainly provided by the electrically conductive material. A sulfide-based solid electrolyte (such as the exemplary sulfide solid electrolyte set forth above) has a high Li⁺ conductivity. However, they generally degrade at potentials below 1.7 V or above 2.1 V vs. Li/Li⁺ at CAM/SE interface, carbon fiber (CF)/SE interface, and/or current collector/SE interface. The degraded byproducts generally have a lower Li⁺ conductivity, which in return requires a higher percentage of SE in the cathode composite layer, leading to a lower percentage of CAM. Without wishing to be bound by theory, the lithium tantalate-hafnate coating disclosed herein prolongs the time for degradation, maintains a relatively higher Li⁺ conductivity, and thus improves the overall battery cell performance.

The cathode active material layer disclosed above can be incorporated into an all-solid-state battery. As shown for example in FIG. 2, the cathode active material layer (5) can act as a positive electrode in the all-solid-state battery (ASSB) and the all-solid-state-battery may also include an anode active material layer (7) and a solid electrolyte (SE) layer (6) between the cathode active material layer (5) and the anode active material layer (7). In some embodiments, the solid electrolyte of the solid electrolyte layer may be the same as or different from the solid electrolyte in the cathode active material layer. In some embodiments, the solid electrolyte layer is an inorganic solid electrolyte layer, for example a sulfur-containing inorganic electrolyte including, but not limited to Li₂S—P₂S₅, Li₂S—P₂S₅—LiHa (“Ha” is one or more halogen elements), Li₂S—P₂S₅—P₂O₅, Li₂S—Li₃PO₄—P₂S₅, Li₃PS₄, Li₄P₂S₆, Li₁₀GeP₂Si₂, Li_{3.25}Ge_{0.25}P_{0.75}S₄, Li₇P₃S₁₁, Li_{3.25}P_{0.95}S₄, and Li₇₋ₓPS₆₋ₓHₐₓ (argyrodite-type solid electrolyte, “Ha” is one or more halogen elements, where 0.2<x<1.8).

In some embodiments, the ASSB has an initial discharge specific capacity of at least 200 mAh/g, at least 205 mAh/g, at least 210 mAh/g or at least 215 mAh/g at 75 °C at a charge/discharge rate of 0.1 C.

In some embodiments, the ASSB has an initial discharge specific capacity of at least 200 mAh/g or at least 205 mAh/g at 75 °C at a charge/discharge rate of 0.33 C.

In some embodiments, the ASSB has an initial discharge capacity retention at 5 C of at least 86.0%, 86.5%, 87.0%, 87.5% or 88.0%, wherein the initial discharge capacity retention at 5 C is calculated by dividing the initial discharge capacity at 5 C by the initial discharge capacity at 0.1 C.

In some embodiments, the ASSB has a 20^{th} cycle stability at 0.5 C of at least 94.0%, 94.5%, or 95.0%, wherein the 20^{th} cycle stability at 0.5 C is the discharge capacity of the 20^{th} cycle at 0.5 C divided by the discharge capacity of the 1^{st} cycle of cycle-life test at 0.5 C.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example 1

A coating solution was prepared by dissolving lithium acetate as lithium precursor, tantalum(V) ethoxide as tantalum oxide precursor, and hafnium (IV) ethoxide as hafnium oxide precursor in anhydrous ethanol as solvent. A predetermined amount of the coating solution was then mixed with CAM particles, wherein the predetermined amount is calculated given a desired coating thickness using the BET surface area of the CAM and an estimated coating density of 6.93 g/cm³. The mixing lasted for 30 minutes followed by solvent removal via vacuum while being sonicated, leading to a gel of CAM coated with the lithium borosilicate. The gel was then annealed for 1 hour at 300 °C under an oxygen flow to form the CAM particles coated with lithium tantalate-hafnate with a formula of (LiTaO₃)₁₋ₓ—(Li₂HfO₃)ₓ; 0<x<1.00.

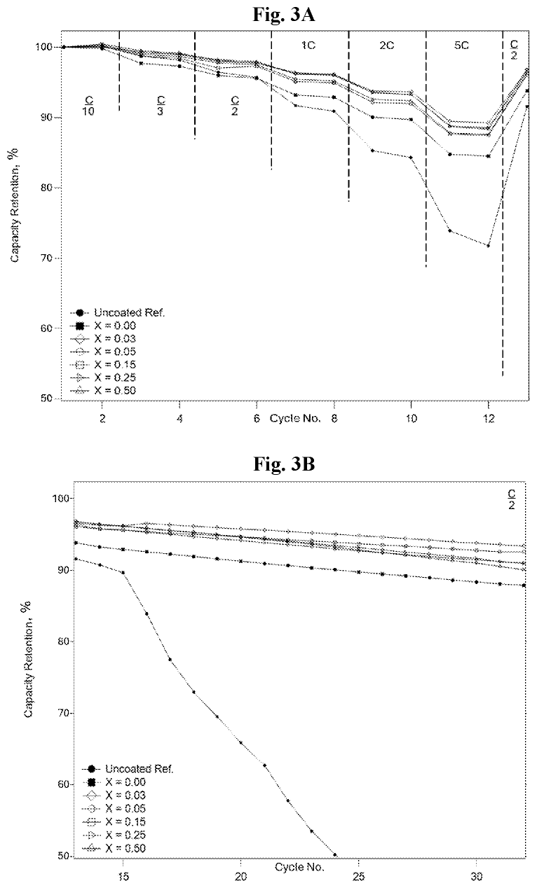

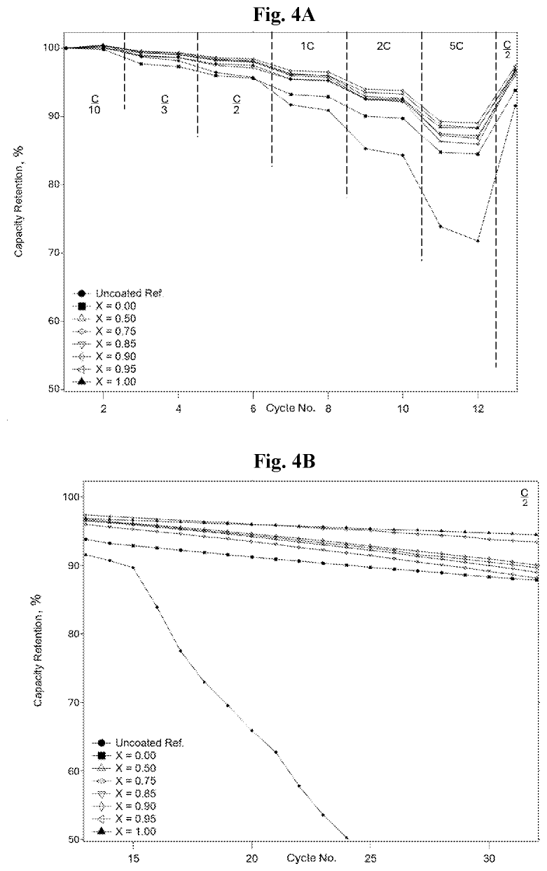

A cathode active material layer comprising 65 wt % uncoated or coated LiNi_{0.88}Co_{0.09}Al_{0.03}O₂ (NCA88) as CAM, 5 wt % carbon fiber (VGCF), and 30 wt % lithium phosphorus sulfur chloride (LPSCl) (Li₆PS₅Cl) was prepared. The cathode active material layers were electrochemically evaluated in torque-cells using Li metal on copper as the anode and Li₆PS₅Cl (LPSCl) as SE. The cells were cycled at 75 °C from 2.5V to 4.25V at 0.1 C charge/discharge for cycles 1 and 2, 0.33 C charge/discharge for cycles 3 and 4, 0.5 C charge/discharge for cycles 5 and 6, 1 C charge/discharge for cycles 7 and 8, 2 C charge/discharge for cycles 9 and 10, 5 C charge/discharge for cycles 11 and 12, and 0.5 C charge/discharge for cycles 13 to 32. The initial capacity retentions at 0.33 C, 0.5 C, 1 C, 2 C and 5 C are calculated by dividing the discharge capacities at 0.33 C, 0.5 C, 1 C, 2 C and 5 C by the initial discharge capacity at 0.1 C, respectively. The 20^{th} cycle stability at 0.5 C is calculated from the 20^{th} cycle-life discharge capacity retention at 0.5 C divided by the 1st cycle-life discharge capacity retention at 0.5 C. As representatively shown in FIG. 3, the 1^{st} and 20^{th} cycle-life discharge capacity retention at 0.5 C are cycle no. 13 and 32, respectively. Note that cycles no. 5 and 6 were tested at 0.5 C as part of the rate test but not part of the cycle-life test for the calculation of cycle-life discharge capacity retention and cycle stability.

The initial specific discharge capacities and capacity retention of the various lithium borosilicate coatings are summarized in Table 1. FIG. 3 shows a plot of cell discharge capacity retention (%) vs. cycle number at 75 °C of half-cells comprising uncoated CAM or coated CAM with lithium tantalate-hafnate, i.e., (LiTaO₃)₁₋ₓ—(Li₂HfO₃)ₓ, x=0, 0.03, 0.05, 0.15, 0.25, 0.50, 0.75, 0.85, 0.90, 0.95 and 1.00. The coating has a thickness of approximately 5.0 nm.

As shown in Table 1, all examples exhibited an initial discharge specific capacity of at least 200 mAh/g at a rate of 0.1 C when 0<x<1.0. Kinetic performance is important for high-rate performance such as fast charge or discharge of an electrochemical device and can be representatively shown by its initial discharge capacity retention at elevated C rates, such as 1 C, 2 C and 5 C. A cell comprising uncoated (U.C.) CAM exhibited an initial discharge capacity retention at 5 C of around 62.82%. It is lower than those comprising lithium borosilicate coated CAM as shown in Table 1, which are higher than 80.0% or even higher than 84.0%.

Furthermore, the results demonstrate the criticality of the coating composition, i.e., value of x in (LiTaO₃)₁₋ₓ—(Li₂HfO₃)ₓ on the high-rate performance. When x is 0, the coating is lithium tantalate (LiTaO₃), the battery exhibited an initial discharge capacity retention of 93.20%, 90.05% and 84.80% at 1 C, 2 C and 5 C, respectively. When x is 1.0, i.e., the coating is lithium hafnate (Li₂HfO₃), the battery exhibited an initial discharge capacity retention of 95.09%, 91.67% and 86.46% at 1 C, 2 C and 5 C, respectively. When x has a value greater than 0 and less than 1.0, i.e., the coating contains both LiTaO₃ and Li₂HfO₃, the cells exhibited an improved high-rate performance at 1 C, 2 C and 5 C in comparison to x=0 and 1.0. Among those tested examples, the cells with x=0.03, 0.05, 0.15, 0.25, 0.50, 0.75, 0.85, 0.90, and 0.95 can achieve an initial discharge capacity retention of at least 95.10% and at least 92.00% at 1 C and 2 C at 75 °C, respectively. The cells with x=0.03, 0.05, 0.15, 0.25, 0.50, 0.85, 0.90, and 0.95 can achieve an initial discharge capacity retention of at least 86.50% at 5 C at 75 C.

TABLE 1
Initial discharge (dChg) specific capacity (Cap.), capacity retention
at 75 °C and different C rates for half-cells comprising uncoated (U.C.) CAM or CAM coated
with (LiTaO₃)₁₋ₓ—(Li₂HfO₃)ₓ, x = 0, 0.03, 0.05, 0.15, 0.25,
0.50, 0.75, 0.85, 0.90, 0.95 and 1.00.

| | Initial Dchg | Initial Dchg | Initial Dchg | Initial Dchg | Initial Dchg | Initial Dchg |
|---|---|---|---|---|---|---|
| | Cap. @ 0.1 C | Cap Ret @ | Cap Ret @ | Cap Ret @ | Cap Ret @ | Cap Ret @ |
| CAM | (mAh/g) | 0.33 C | 0.5 C | 1 C | 2 C | 5 C |
| U.C. | 210.98 | 99.89% | 96.20% | 89.08% | 79.72% | 62.82% |
| 0 | 215.15 | 97.74% | 95.96% | 93.20% | 90.05% | 84.80% |
| 0.03 | 202.13 | 99.16% | 97.98% | 96.26% | 93.78% | 89.45% |
| 0.05 | 214.93 | 98.98% | 97.76% | 95.46% | 92.61% | 87.82% |
| 0.15 | 212.31 | 98.77% | 97.07% | 95.15% | 92.17% | 87.67% |
| 0.25 | 223.27 | 99.52% | 98.11% | 96.37% | 93.52% | 88.81% |
| 0.50 | 213.63 | 99.41% | 98.27% | 96.11% | 93.36% | 88.41% |
| 0.75 | 208.32 | 99.41% | 98.33% | 95.99% | 92.51% | 86.34% |
| 0.85 | 219.07 | 99.73% | 98.63% | 96.39% | 93.47% | 88.26% |
| 0.90 | 212.85 | 99.58% | 98.46% | 96.28% | 92.98% | 87.23% |
| 0.95 | 220.80 | 99.55% | 98.61% | 96.70% | 94.04% | 89.29% |
| 1.00 | 199.86 | 99.61% | 97.95% | 95.09% | 91.67% | 86.46% |

Cycling performance is also important for an electrochemical device. Cycle-life stability can be typically measured by 20^{th} cycle stability at 0.5 C, which is the discharge capacity of the 20^{th} cycle at 0.5 C divided by the discharge capacity of the 1^{st} cycle of cycle-life test at 0.5 C. As shown in Table 2, a cell comprising uncoated CAM exhibited a 20^{th} cycle stability at 0.5 C of around 65.37%. It is significantly lower than those with a coated CAM.

TABLE 2
Initial discharge (dChg) specific capacity (Cap.) and 20^{th} cycle
stability at 75 °C for half-cells comprising uncoated (U.C.) CAM
or CAM coated with (LiTaO₃)₁₋ₓ—(Li₂HfO₃)ₓ, x = 0, 0.03, 0.05,
0.15, 0.25, 0.50, 0.75, 0.85, 0.90, 0.95 and 1.00.

| | Initial Dchg Cap @ | Initial Dchg Cap. @ | 20^{th} Cycle Stability |
|---|---|---|---|
| CAM | 0.1 C (mAh/g) | 0.5 C (mAh/g) | @ 0.5 C (%) |
| U.C. | 210.98 | 176.87 | 65.37% |
| 0.00 | 215.15 | 201.84 | 93.65% |
| 0.03 | 202.13 | 188.78 | 96.44% |
| 0.05 | 214.93 | 206.92 | 94.42% |
| 0.15 | 212.31 | 203.93 | 96.37% |
| 0.25 | 223.27 | 216.13 | 94.00% |
| 0.50 | 213.63 | 205.94 | 93.34% |
| 0.75 | 208.32 | 201.27 | 92.13% |
| 0.85 | 219.07 | 211.95 | 91.84% |
| 0.90 | 212.85 | 206.02 | 92.60% |
| 0.95 | 220.80 | 215.04 | 95.90% |
| 1.00 | 199.86 | 191.67 | 92.65% |

The results demonstrate that the coating composition, i.e., value of x in (LiTaO₃)₁₋ₓ—(Li₂HfO₃)ₓ plays a significant role in governing the cycling performance. The cell comprising CAM coated with lithium tantalate (LiTaO₃, x=0) and lithium hafnate (Li₂HfO₃, x=1.0) exhibited a 20^{th} cycle stability of 93.65% and 920.65%, respectively. When x is greater than 0 and less than 1.0, only certain compositions can achieve a cycling stability better than x=0 and x=1.0, which is different from the high-rate performance. For example, when x has a value of 0.50, 0.75, 0.85 and 0.90, a cell exhibited a 20^{th} cycle stability at 0.5 C of 93.34%, 92.13%, 91.84% and 92.60%, respectively. They are lower than that of a cell with lithium tantalate (x=0). Among those tested examples, only when x is 0.03, 0.05, 0.15, 0.25 or 0.95, the CAM coating can achieve a 20^{th} cycle stability at 0.5 C of at least 94.0%.

In practical applications, tradeoff between high-rate performance and high cycling in all solid-state batteries is a critical consideration. It is challenging to achieve both good high-rate performance and high cycling performance simultaneously. In one aspect, the present disclosure provides an all solid-state battery (ASSB) that can simultaneously achieve a desirable high-rate performance, for example an initial discharge capacity retention of at least 95.10% at 1 C, at least 92.00% at 2 C, and/or at least 86.50% at 5 C at 75 °C, and a good cycling performance for example a 20^{th} cycle stability at 0.5 C of at least 94.0% at 75 °C. In some embodiments, the ASSB comprises a cathode active material layer comprising a coated cathode active material (CAM) particle comprising a coating represented by a formula of (LiTaO₃)₁₋ₓ—(Li₂HfO₃)ₓ; 0.03≤x≤0.25, or 0.85<x<1.00. In some embodiments, x has a value of around 0.95.

### Aspects

In a first aspect of the disclosure, a coated cathode active material particle comprising particle of a cathode active material (CAM) and a coating on the particle, wherein the coating is lithium tantalate-hafnate is represented by a formula of (LiTaO₃)₁₋ₓ—(Li₂HfO₃)ₓ; 0<x<1.00.

In a second aspect according to the first aspect, x has a value in a range from 0.03 to 0.25, i.e., 0.03≤x≤0.25.

In a third aspect according to the second aspect, the coating is represented by a formula selected from the group consisting of (LiTaO₃)_{0.97}—(Li₂HfO₃)_{0.03}, (LiTaO₃)_{0.95}—(Li₂HfO₃)_{0.05}, (LiTaO₃)_{0.90}—(Li₂HfO₃)_{0.10}, (LiTaO₃)_{0.85}—(Li₂HfO₃)_{0.15}, (LiTaO₃)_{0.80}—(Li₂HfO₃)_{0.2}O, (LiTaO₃)_{0.75}—(Li₂HfO₃)_{0.25}, and mixtures thereof.

In a fourth aspect according to the first aspect, 0.85<x<1.00.

In a fifth aspect according to the fourth aspect, x has a value around 0.95.

In a sixth aspect according to the first aspect, the coating has a thickness in a range from 0.5 nm to 20 nm.

In a seventh aspect, the present disclosure provides a cathode active material layer comprising the coated CAM particle according to the first aspect with at least 65 wt % of the coated CAM particle in the cathode active material layer.

In an eighth aspect according to the seventh aspect, the cathode active material layer further comprises an electrically conductive material and a sulfur-containing inorganic electrolyte, wherein the sulfur-containing inorganic electrolyte is selected from the group consisting of Li₂S—P₂S₅, Li₂S—P₂S₅—LiHa, Li₂S—P₂S₅—P₂O₅, Li₂S—Li₃PO₄—P₂S₅, Li₃PS₄, Li₄P₂S₆, Li₁₀GeP₂Si₂, Li_{3.25}Ge_{0.25}P_{0.75}S₄, Li₇P₃S₁₁, Li_{3.25}P_{0.95}S₄, Li_{7-y}PS_{6-y}Ha_{y}, and mixtures thereof wherein “Ha” is one or more halogen elements, and 0.2<y<1.

In a nineth aspect according to the eighth aspect, the electrically conductive material comprises a carbon fiber.

In a tenth aspect according to the nineth aspect, the carbon fiber comprises at least one selected from the group consisting of vapor grown carbon fiber (VGCF), carbon nanotube (CNT), multi-walled carbon nanotubes (MWCNT), carbon nanofiber, and graphite fiber.

In an eleventh aspect, the present disclosure provides an all-solid-state battery (ASSB) comprising a cathode layer comprising a cathode current collector and the cathode active material layer according to the seventh aspect, an anode layer and an inorganic solid electrolyte layer between the cathode active material layer and the anode layer. In some embodiments, the ASSB possesses at least one characteristic of the following:
an initial discharge specific capacity of at least 200 mAh/g at 75 °C at a discharge rate of 0.1 C;
an initial discharge capacity retention of at least 86.5% at 75 °C at 5 C; and
a 20^{th} cycle stability of at least 94.0% at 75 °C at 0.5 C,
   wherein the initial discharge capacity retention at 5 C is calculated by dividing the initial discharge capacity at 5 C by the initial discharge capacity at 0.1 C, the 20^{th} cycle-life capacity retention is calculated by dividing the discharge capacity of the 20^{th} cycle at 0.5 C by the initial discharge capacity at 0.1 C, and the 20^{th} cycle stability is calculated by dividing the 20^{th} cycle-life capacity retention at 0.5 C by the 1^{st} cycle-life capacity retention at 0.5 C.

In a twelfth aspect according to the eleventh aspect, the inorganic solid electrolyte layer comprises a sulfur-containing inorganic electrolyte, wherein the sulfur-containing inorganic electrolyte comprises at least one selected from the group consisting of Li₂S—P₂S₅, Li₂S—P₂S₅—LiHa, Li₂S—P₂S₅—P₂O₅, Li₂S—Li₃PO₄—P₂S₅, Li₃PS₄, Li₄P₂S₆, Li₁₀GeP₂Si₂, Li_{3.25}Ge_{0.25}P_{0.75}S₄, Li₇P₃S₁₁, Li_{3.25}P_{0.95}S₄, Li_{7-y}PS_{6-y}Ha_{y}, and mixtures thereof wherein “Ha” is one or more halogen elements, and 0.2<y<1.

In a thirteenth aspect according to the twelfth aspect, the anode layer comprises an anode active material layer formed either before first cycle or after the first cycle.

In a fourteenth aspect according to the thirteenth aspect, the anode active material layer comprises lithium metal or lithium alloy.

In a fifteenth aspect, the present disclosure provides a method for preparing the coated CAM particle according to one of the first through sixth aspects. The method comprises:
a) preparing a coating solution comprising a predetermined amount of a lithium precursor, a tantalum oxide precursor and a hafnium oxide precursor in a solvent,
b) mixing the coating solution with an uncoated cathode active material into a mixture,
c) removing the solvent from the mixture, leading to a coating of gel formed on the CAM, and
d) annealing the coating of gel on the CAM in an oxygen atmosphere, wherein the lithium precursor, the tantalum oxide precursor and the hafnium oxide precursor are converted into a coating of lithium tantalate-hafnate, thereby obtaining a coated CAM particle, wherein the coating is (LiTaO₃)₁₋ₓ—(Li₂HfO₃)ₓ; 0<x<1.00.

In a sixteenth aspect according to the fifteenth aspect, 0.03≤x≤0.25.

In a seventeenth aspect according to the fifteenth aspect, the lithium precursor comprises at least one selected from the group consisting of lithium acetate, lithium ethoxide, lithium isopropoxide, lithium methoxide and mixtures thereof.

In an eighteenth aspect according to the fifteenth aspect, the tantalum oxide precursor comprises at least one selected from the group consisting of tantalum(V) methoxide, tantalum(V) ethoxide, tantalum(V) isopropoxide, tantalum(V) n-butoxide, tantalum(V) t-butoxide, and mixtures thereof.

In a nineteenth aspect according to the fifteenth aspect, the hafnium oxide precursor comprises at least one selected from the group consisting of hafnium (IV) ethoxide, hafnium (IV) isopropoxide, hafnium (IV) n-butoxide, hafnium (IV) t-butoxide, hafnium (IV) acetylacetonate, and mixtures thereof.

In a twentieth aspect according to the fifteenth aspect, the solvent is non-aqueous and comprises at least one selected from the group consisting of methanol, ethanol, isopropanol, n-propanol, t-butanol, tetrahydrofuran, and mixtures thereof.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. A coated cathode active material (CAM) particle comprising particle of a cathode active material (CAM) and a coating on the particle, wherein the coating is represented by (LiTaO₃)₁₋ₓ—(Li₂HfO₃)ₓ; 0<x<1.00.

2. The coated CAM particle of claim 1 wherein 0.03≤x≤0.25.

3. The coated CAM particle of claim 2, wherein the coating is represented by a formula selected from the group consisting of (LiTaO₃)_{0.97}—(Li₂HfO₃)_{0.03}, (LiTaO₃)_{0.95}—(Li₂HfO₃)_{0.05}, (LiTaO₃)_{0.90}—(Li₂HfO₃)_{0.10}, (LiTaO₃)_{0.85}—(Li₂HfO₃)_{0.15}, (LiTaO₃)_{0.75}—(Li₂HfO₃)_{0.25} and mixtures thereof.

4. The coated CAM particle of claim 1 wherein 0.85<x<1.00.

5. The coated CAM particle of claim 4, wherein x has a value of around 0.95.

6. The coated CAM particle of claim 1, wherein the coating has a thickness in a range from 0.5 nm to 20 nm.

7. A cathode active material layer comprising the coated CAM particle of claim 1 with a percentage of at least 65 wt % of the coated CAM particle in the cathode active material layer.

8. The cathode active material layer of claim 7, further comprising an electrically conductive material and a sulfur-containing inorganic electrolyte, wherein the sulfur-containing inorganic electrolyte is selected from the group consisting of Li₂S—P₂S₅, Li₂S—P₂S₅—LiHa, Li₂S—P₂S₅—P₂O₅, Li₂S—Li₃PO₄—P₂S₅, Li₃PS₄, Li₄P₂S₆, Li₁₀GeP₂S₁₂, Li_{3.25}Ge_{0.25}P_{0.75}S₄, Li₇P₃S₁₁, Li_{3.25}P_{0.95}S₄, Li_{7-y}PS_{6-y}Ha_{y}, and mixtures thereof wherein “Ha” is one or more halogen elements, and 0.2<y<1.

9. The cathode active material layer of claim 8, wherein the electrically conductive material comprises a carbon fiber.

10. The cathode active material layer of claim 9, wherein the carbon fiber comprises at least one selected from the group consisting of vapor grown carbon fiber (VGCF), carbon nanotube (CNT), multi-walled carbon nanotubes (MWCNT), carbon nanofiber, and graphite fiber.

11. An all-solid-state battery (ASSB) comprising a cathode layer comprising the cathode active material layer of claim 7 and a cathode current collector, an anode layer and an inorganic solid electrolyte layer between the cathode active material layer of the cathode layer and the anode layer.

12. The ASSB of claim 11, wherein the inorganic solid electrolyte layer comprises a sulfur-containing inorganic electrolyte, wherein the sulfur-containing inorganic electrolyte comprises at least one selected from the group consisting of Li₂S—P₂S₅, Li₂S—P₂S₅—LiHa, Li₂S—P₂S₅—P₂O₅, Li₂S—Li₃PO₄—P₂S₅, Li₃PS₄, Li₄P₂S₆, Li₁₀GeP₂Si₂, Li_{3.25}Ge_{0.25}P_{0.75}S₄, Li₇P₃Si₁, Li_{3.25}P_{0.95}S₄, Li_{7-y}PS_{6-y}Ha_{y}, and mixtures thereof wherein “Ha” is one or more halogen elements, and 0.2<y<1.

13. The ASSB of claim 11, wherein the anode layer comprises an anode current collector and an anode active material layer formed either before first cycle or after the first cycle.

14. The ASSB of claim 13, wherein the anode active material layer comprises lithium metal or lithium alloy.

15. A method for preparing the coated CAM particle of claim 1, comprising:
a) preparing a coating solution comprising a predetermined amount of a lithium precursor, a tantalum oxide precursor and a hafnium oxide precursor in a solvent,
b) mixing the coating solution with an uncoated cathode active material into a mixture,
c) removing the solvent from the mixture, leading to a coating of gel formed on the CAM, and
d) annealing the coating of gel on the CAM in an oxygen atmosphere, wherein the lithium precursor, the tantalum oxide precursor and the hafnium oxide precursor are converted into a coating of lithium tantalate-hafnate, thereby obtaining a coated CAM particle, wherein the coating is (LiTaO₃)₁₋ₓ—(Li₂HfO₃)ₓ; 0<x<1.00.

16. The method of claim 15, wherein 0.03≤x≤0.25.

17. The method of claim 15, wherein the lithium precursor comprises at least one selected from the group consisting of lithium acetate, lithium ethoxide, lithium isopropoxide, lithium methoxide and mixtures thereof.

18. The method of claim 15, wherein the tantalum oxide precursor comprises at least one selected from the group consisting of tantalum(V) methoxide, tantalum(V) ethoxide, tantalum(V) isopropoxide, tantalum(V) n-butoxide, tantalum(V) t-butoxide, and mixtures thereof.

19. The method of claim 15, wherein the hafnium oxide precursor comprises at least one selected from the group consisting of hafnium (IV) ethoxide, hafnium (IV) isopropoxide, hafnium (IV) n-butoxide, hafnium (IV) t-butoxide, hafnium (IV) acetylacetonate, and mixtures thereof.

20. The method of claim 15, wherein the solvent is non-aqueous and comprises at least one selected from the group consisting of methanol, ethanol, isopropanol, n-propanol, t-butanol, tetrahydrofuran, and mixtures thereof.
